(19) United States
(12) Patent Application Publication
(10) Pub. No.: US 2016/0237985 A1
(43) Pub. Date: Aug. 18, 2016

(54) Device and Method for Handling, Mounting or Dismantling Components of a Wind Turbine

(71) Applicant: MAX BÖGL WIND AG, Sengenthal (DE)

(72) Inventors: Stefan Bögl, Sengenthal (DE); Johann Wild, Postbauer-Heng (DE)

(21) Appl. No.: 15/024,138

(22) PCT Filed: Sep. 4, 2014
(86) PCT No.: PCT/EP2014/068824

§ 371 Date: Mar. 23, 2016

(30) Foreign Application Priority Data
Sep. 23, 2013 (DE) 10 2013 110 464.9

(51) Int. Cl. F03D 1/00; B66C 23/20; B66C 23/18; F03D 1/06; F03D 3/06

(52) U.S. Cl. CPC F03D 1/001; F03D 1/0675; F03D 3/064; B66C 23/185; B66C 23/207

(57) ABSTRACT

A device for handling, mounting and/or dismantling components of a wind turbine using a crane includes a support movable in the direction of a longitudinal axis of the crane and attachable to the crane; and at least one guying device having a first end attachable to the movable support a second end attachable to the component in order to stabilize the position of the component. The guying device is rotatably attached to the support around a longitudinal axis of the crane. A related method employs a guying device movable around a crane longitudinal axis.

### CROSS-REFERENCE TO RELATED APPLICATIONS

This application is a national stage of International Application No. PCT/EP2014/068824, filed Sep. 4, 2014 and claims benefit to German Patent Application No. 10 2013 110 464.9 filed Sep. 23, 2013, both of which are incorporated by reference herein.

### TECHNICAL FIELD

This invention refers to a device to handle, mount or dismantle components of a wind turbine, especially rotor blades and/or a nacelle, with the aid of a crane. The device comprises a movable support, which can be moved in the direction of a longitudinal axis of the crane and can be attached to it. Furthermore, the device comprises at least a guying device, preferably a guy cable, whose first end is attached to the movable support and whose second end can be attached to the wind turbine component in order to stabilize the position of the component during handling and mounting. In addition, the invention refers to a corresponding method in which the position of a component to be lifted during the handling and mounting or dismantling is stabilized with at least one guying device. Here, the at least one guying device is moved towards a longitudinal axis of the crane while the component is moved vertically during hoisting.

### BACKGROUND

When wind turbines are erected, a crane has to pick up individual components of the wind turbine, such as sections of a wind turbine tower or functional components such as rotor blades, the nacelle or the hub as well, and mount them on the already erected structure. When doing so, it is often necessary to bring the components to be mounted in a certain position so they can be attached to the structural section that is already in place, something that is hard to do with the current hub heights that exceed 120 m. In particular, when rotor blades are mounted, it is for example necessary to lift them in a very specific position so they can be attached to the rotor hub, which likewise takes a very specific position. Thus, several devices and methods have been published in the state of the art to control the position of the component to be mounted. For example, it has been made known that a rotor blade of a wind turbine is lifted in horizontal position so it can be attached to the hub that has been turned accordingly. So the next rotor blade can be mounted, the hub must always be turned further by a certain angle. Since angular deviations of the rotor blade make it impossible to mount it on the hub, guy cables manually held from the ground are arranged on the rotor blade to adjust the latter's position. Adjusting the rotor blade so it is in the required mounting position is difficult in this case because the persons on the ground holding the guy cables cannot see the mounting situation up on the hub.

Therefore, EP 1 925 582 B1 provides that the guy cables for adjusting the horizontal mounting position of a rotor blade not to be held with the hands, but instead suggests the use of a winch arranged in the crane's floor area, to adjust it. In this case, the guy cables are led over a deflection arranged on the crane.

On the other hand, WO 2011/048220 A1 suggests arranging the cable winches on a sled that can be moved on guide rails arranged in vertical direction on the crane tower to control the guy cables.

### SUMMARY

The task of the present invention is to provide a device for handling and mounting or dismantling components of a wind turbine to allow a more flexible handling and the most varied mounting positions. The task is solved with the characteristics of the disclosed subject matter.

A device for handling, mounting or dismantling components of components of a wind turbine, especially of rotor blades and/or a nacelle, with the aid of a crane comprises a movable support. The support can be moved in the direction of a longitudinal axis of the crane and attached to it. Here, the longitudinal axis of the crane is understood to be a crane tower's middle axis oriented largely in vertical direction or a main boom of the crane. Preferably, the support is movably connected with a crane mast, whereby depending on the type of crane, the crane mast can be a boom or crane tower of a rotating tower crane. To displace it along the crane's longitudinal axis, the support has guiding devices (e.g. rollers, sleds or the like) that define a driving direction on the support. The support can be attached in such a way to the crane that the driving direction of the support corresponds to the crane's longitudinal axis, especially that of a crane tower. Moreover, the device comprises a guying device, preferably a guy cable, whose first end is attached to the movable support and whose second end is attached to the wind turbine component in order to stabilize the component during handling and mounting. In a method to handle, mount or dismantle components of a wind turbine with the aid of a crane, the position of the component during handling and/or dismantling is stabilized with at least one guying device. In this case, the at least one guying device is moved towards a crane's longitudinal axis while the component is vertically hoisted. It is now provided that before and/or during and/or after a vertical hoisting of the component, the at least one guying device is turned around the crane's longitudinal axis. In order to do this in the respective device, the guying device is rotatably attached around the longitudinal axis of the crane, preferably by at least 90°, to the support. In this case, the guying device is preferably rotatably attached to the support by at least 360°, very preferably by at least 380° or completely freely rotatably attached to it.

Owing to the fact that not only the height of the component can be controlled now but that owing to the rotatable guying device, various angular positions of the component (e.g. of a rotor blade both with regard to the vertical and to the horizontal and thus with regard to the high axis of the wind turbine) are feasible, many different mounting positions of the components to be lifted are now possible. For example, in rotor blades, the mounting position is no longer restricted to only one horizontal position. It is furthermore advantageous that any changes in direction, from the picking up of the component on the ground all the way to the lifting to mounting height, are possible during the lifting path to dodge other structural parts or construction site installations, for example. It is also especially preferable in a guying device rotatable around the longitudinal axis of the crane tower that even when the structure to be erected exceeds the height of the mounting crane it is still possible to have any swiveling movements around the structure or the crane's longitudinal axis. Thus, when rotor blades are mounted on wind turbines, it can happen that, at least after mounting the first rotor blade or in cases in which the entire, fully mounted rotor is lifted up to the top, the erected structure surpasses the height of the crane after the rotor star has been mounted. The movement options of the crane boom are very limited owing to the danger of the crane colliding with the structure. By means of the guying device that can be rotated around the crane's longitudinal axis or the support's driving direction, it is now nonetheless possible to execute swiveling movements while handling components.

According to an advantageous further development of the invention, a guide rail has been arranged on the support that extends preferably in a 90° angle with regard to the longitudinal axis of the crane or the driving direction of the support. However, it is also conceivable to arrange the guide rail on the support in a slightly inclined way to attain a downward or upward swiveling movement, for example. Preferably, the guide rail is executed in the shape of a circular ring segment or a circle so the guying device can be rotated around the longitudinal axis. It is likewise also conceivable to execute the guide rail so that it has an elliptical or irregularly arched shape. In any case, it is once again advantageous if the guide rail allows at least an approximate rotation of 90°.

In a method to handle components of a wind turbine it is once again advantageous if the at least one guying device is guided on a circular path around the longitudinal axis of the crane tower. The advantage of the circular path is the largely constant separation of the component to the support, so that even non-adjustable guying devices such as fixed bracing rods can be used in principle. These fixed bracing rods allow an easy and especially good stabilization of the components because of their considerable stiffness and therefore they can prevent undesired tilting movements or oscillations of the components out of the desired position.

According to an advantageous further development of the invention, the guide rail is firmly arranged on the support and at least one guiding sled is pivot mounted on the guide rail. In this case, the at least one guying device is not directly attached to the support but the guiding sled is used. When the guiding sled is moved on the guide rail, the guying device is turned. However, a conceivable alternative is to guide the guide rail so it can move and be turned along mounting points firmly arranged on the crane tower. In this case, the guying device can be firmly attached to the guide rail.

According to another embodiment of the invention, the guide rail is firmly arranged on the support and an attachment with at least one guiding sled is movably arranged on a guide rail. The at least one guying device is, in turn, connected to the support by means of the attachment. With such an attachment it is possible, for example, to arrange two or more guying devices on the guide rail separated from one another, in which case if the attachment is designed accordingly, wide separations that even exceed the dimensions of the guide rail itself are also possible. As a result of this, an especially stable and stiff tension of the components to be handled can be attained, although guy cables can nonetheless be used too.

It is furthermore advantageous if the attachment and/or at least one guiding sled can be fixed in place on the guide rail. Through this, it is possible to exactly maintain the once adjusted position of the component with regard to its angle to the crane's longitudinal axis while a lifting movement takes place. This is advantageous especially in cramped spaces or with very large components such as rotor blades because this prevents collisions and subsequent damages.

According to an advantageous further development of the invention, the device also has a seat for mounting the wind turbine component. The at least one guying device can then be attached to the wind turbine component by means of the seat. Such a seat makes it possible to also transport delicate components of a wind turbine, such as rotor blades, safely. Furthermore, this also facilitates the attachment of the guying device to the component through the seat. Accordingly, the component doesn't need to have any devices to fasten the guying device that could weaken the component.

It is furthermore particularly advantageous if the guying device is a guy cable and at least one winch is arranged on the at least one guiding sled and/or on the attachment and/or on the seat with which the length of the at least one guy cable can be changed. Thus, by lengthening or shortening the separation of the components to the crane's longitudinal axis or by changing the length of the guying device, more positional changes of the component can be achieved. In particular, when at least two guying devices are provided, the component can have the most varied positions with regard to the wind turbine.

It is furthermore particularly advantageous if the at least one winch is operated by radio and can thus be remotely controlled from the ground or the crane's operator cabin. The position of the component can be controlled and readjusted or changed at all times by operating the winches if certain swiveling movements are necessary. In this case, it is especially advantageous if the at least one winch is battery operated because it can then be very easily fixed in place on the crane tower with the support without having to guide supply lines along.

An especially advantageous embodiment of the invention provides the attachment with at least two guiding sleds and at least two winches. Especially preferable here is that both the guide rails and the winches are arranged at a distance from one another in order to allow tip-stable positioning of the component in the area of its center of gravity.

In addition, it is advantageous if the at least one guying device is guided on the circular path in a controlled movement. To do this, the at least one guying device and/or the attachment includes at least one guiding sled equipped with a travel drive so the rotation of the guying device can be controlled completely independently from the component's lifting movement in order to adjust the desired position of the component. However, greatly improved flexibility of the device can furthermore be already attained by means of a freely movable sled on the rail or a guying device freely movable on the rail. Thus, in spite of the bracing on the crane, particularly on the crane tower of a rotating tower crane, a swiveling of the boom with the component is possible even with an already picked-up component.

In a method to handle components of a wind turbine, the component is lifted by means of a seat and the at least one guying device is fixed in place on the seat while doing so.

To guide the support on the crane, it is especially advantageous if the support has rollers and the rollers can be guided directly on the crane, preferably directly on the corner posts of a crane tower. The constructive structure of the device can be kept very simply as a result of this. No additional guiding agents such as guide rails are necessary to guide the support.

It is also advantageous if the support completely surrounds the crane. Thus, especially if the support fully surrounds the crane tower of a rotating tower crane, it is very easily possible to have a guide directly on the corner posts of the crane tower and at the same time this makes it easily possible to have a circumferential guiding arrangement.

In the method to handle a component of a wind turbine, it is additionally advantageous if the support is guided largely synchronously with the lifting movement of the component in the direction of the crane's longitudinal axis. This makes it possible to always maintain an advantageous short separation between the component and the support so that it becomes very easy to control the position of the component and this position can always be maintained in a stable way. Likewise, the movement of the support in synchrony with the lifting movement allows the use of stiff bracing rods, which also facilitate the attainment of great stability while the component is being handled.

### BRIEF DESCRIPTION OF THE DRAWINGS

Further advantages of the invention are described with the help of the embodiments presented below, which show:

FIG. 1 is an overview display of the mounting of a wind turbine with a device according to the invention or a method for mounting of a wind turbine according to the invention,

FIG. 2 is a schematic top view of a first embodiment of a device for handling components of a wind turbine,

FIG. 3 is a schematic top view of an alternative embodiment of a device,

FIG. 4 is a detailed view of a support of a device mounted on a crane tower,

FIG. 5 is another detailed view of a support mounted on a crane tower with a guide rail and a guiding sled,

FIG. 6 is a schematic top view of a device with an attachment and a seat, and

FIG. 7 is another overview display of a device and a method for handling components of a wind turbine.

### DETAILED DESCRIPTION

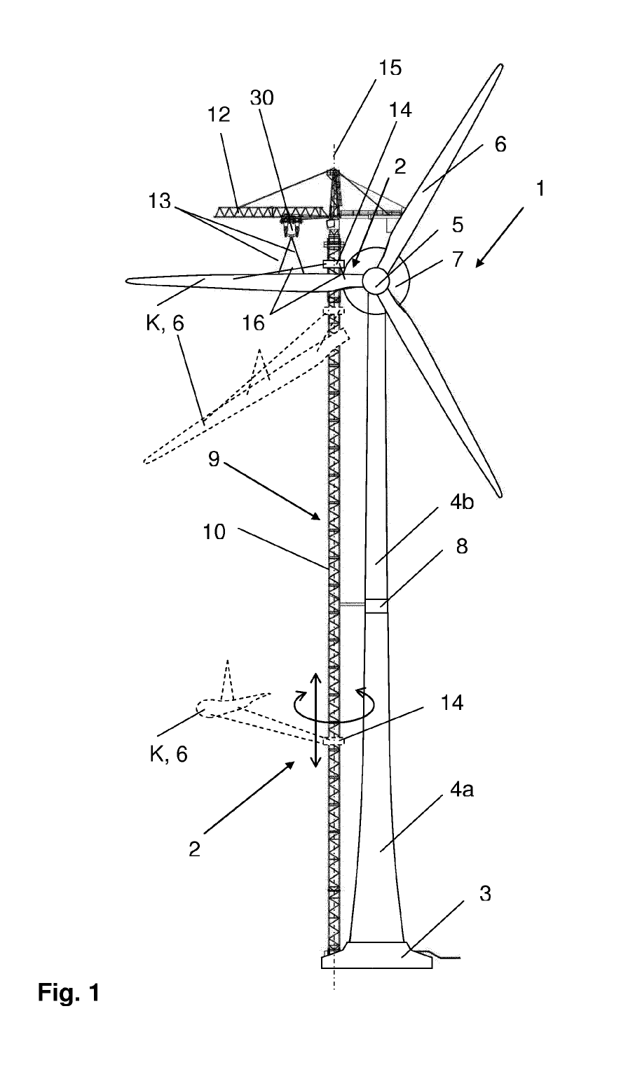

FIG. 1 shows a schematic overview display of a device and a method for handling, mounting or dismantling components of a wind turbine and a wind turbine 1 under construction. Here, it is known that the wind turbine consists of a foundation 3, a tower 4, and various functional units from which the hub 5 with the rotor blades 6 and the nacelle 7 can be recognized. According to this drawing, the tower 4 is subdivided into two sections 4a, 4b connected to one another by an intermediate piece 8. In principle, the tower 4 can be made of in-situ concrete, prefabricated concrete parts or steel or be made from various materials in a hybrid construction. Preferably, the lower section 4a of the tower is made of prefabricated concrete parts braced against one another between the intermediate piece 8 and the foundation 3, as well as of a steel pole placed on top as second section 4b, which can be one part or consist likewise of several segments.

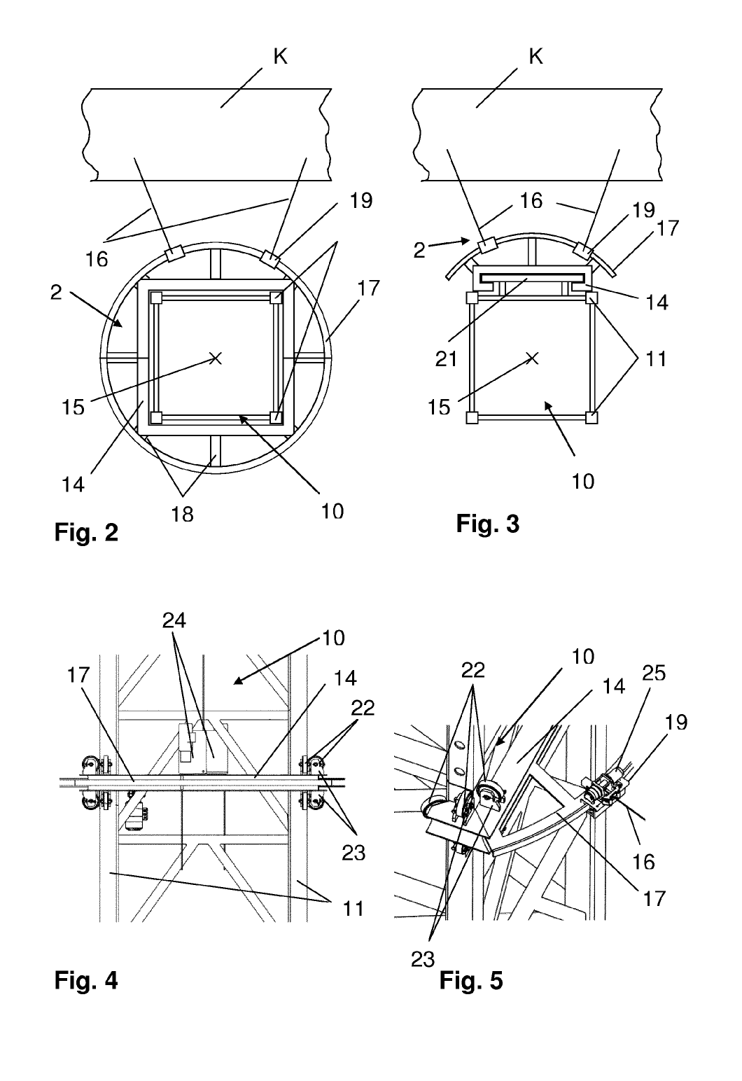

To mount the functional units 5, 6, 7 on the already erected tower 4, a crane 9 is provided, according to this drawing, a rotating tower crane 9. Here, it is naturally also possible to erect parts of the tower 4 or also the entire tower 4 already with the help of the rotating tower crane 9. In this case, the rotating tower crane 9 has been placed on the foundation 3 of the wind turbine 1 and anchored to the tower 4 by means of an anchorage 32 in the area of the intermediate piece 8, to attain high stability even at great heights. However, the invention can also be used with other types of cranes, in which case the cranes do not have to be anchored to the tower 4 of the wind turbine 1. Likewise, a crane can naturally also be placed separately in the area of the wind turbine 1 and does not necessarily have to stand on the foundation 3. In this case, the crane 9 has a crane tower 10, which includes four corner posts 11 (FIGS. 2 and 3). Here, the crane 9 has a boom 12 with hoist hooks 20 movable on it used to hoist components K such as the hub 5, rotor blades 6, nacelle 7, intermediate piece 8 or also prefabricated concrete parts of the tower 4 (not shown) conventionally with load cables 13.

As can now be recognized in the upper part of FIG. 1 near the hub 5, a device 2 to handle, mount or dismantle components K of the wind turbine 1 has been additionally provided. The device 2 comprises a support 14 attached here to a crane mast of the crane 9, here the crane tower 10, and can be moved towards a longitudinal axis 15 of the crane 9, here of the crane tower 10. If the device 2 is not used on a rotating tower crane 9 but on another type of crane, then the support 14 is attached accordingly to a boom or crane mast and can be moved on it. According to this drawing, two guying devices 16—which can be executed as guy cables 16a or bracing rods 16b—are arranged between the support 14 and the component K to be handled, in this case a rotor blade 6. The first end of the guying devices 16 are connected to the support 14 and on their other end with the component K, here the rotor blade 6. As a result of this, the component K is braced in such a way against the crane tower 10 that its position can always be maintained stable with regard to the crane tower 10 or, in the case of an adjustable guying device 16, also be selectively changed in order to achieve a certain mounting position, for example.

As the dashed representation in the lower part of FIG. 1 shows, the support 14 can be moved along the longitudinal axis 15, and furthermore the guying device can be rotated around the longitudinal axis 15 of the crane 9, here of the crane tower 10, as the arrows symbolize. Apart from the guying devices 16, a rotor blade 6 can be recognized in a position that is turned with respect to the upper area, and the load cables 13.

As can now be gathered from FIG. 1, it is possible to pick up a component in a position, turn it upward during hoisting and then bring it finally in mounting position, for example. This simplifies the construction site installation because components K no longer have to be provided in a certain position on the ground, for example. As the dashed representation of FIG. 1 shows in the middle area, it is also possible to adjust various angular positions of components K so that when rotor blades 6 are mounted, for example, they do not have to be mounted any longer only in a horizontal or strictly vertical position. It is thus no longer also absolutely necessary to turn the rotor further by 120° to mount the individual rotor blades 6, as the state of the art was doing it.

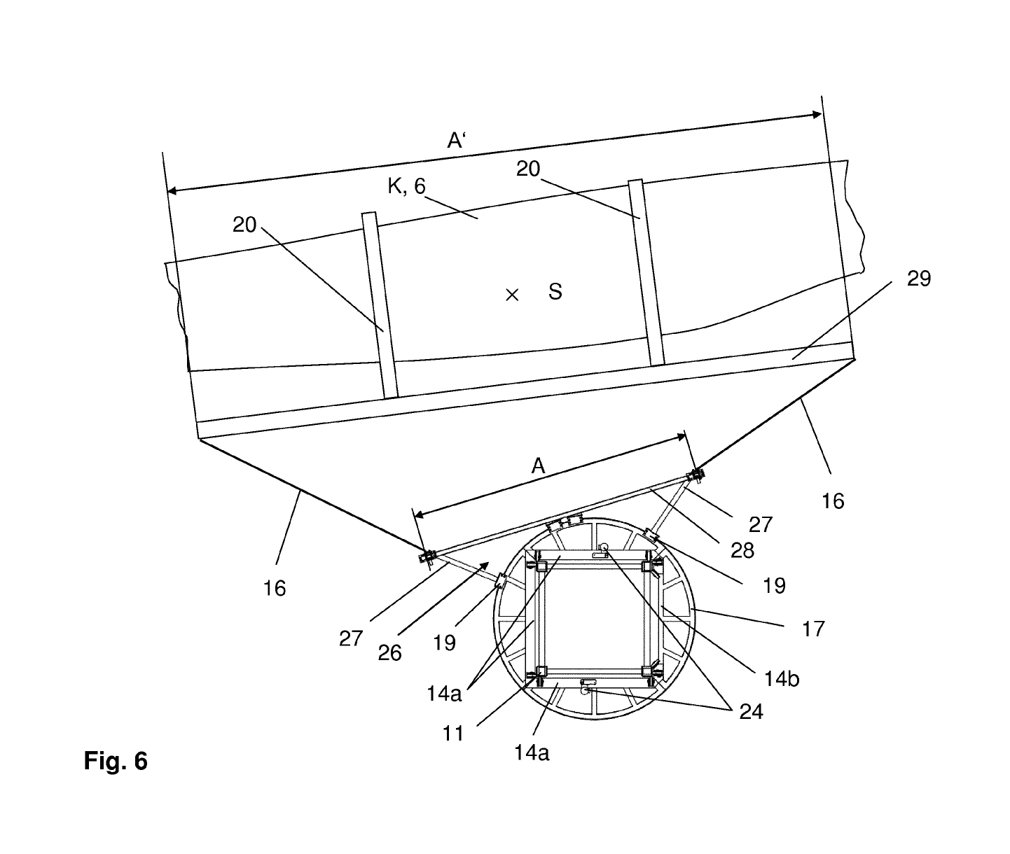

FIG. 2 now shows a first execution of a device 2. The device 2 includes the support 14, which surrounds here the crane tower 10 completely with its corner posts 11. To mount the support 14 on the crane tower 10, the support 14 has been executed here as separable. Basically, the support 14 can be made up of two or even several support sections 14a, 14b (see FIG. 6) in order to facilitate the mounting on the crane tower 10. So it can be moved along the crane's longitudinal axis, the support 14 has guiding devices such as rollers 22, sleds or the like (see FIGS. 4 and 5), which define a travel direction on the support 14. When the support 14 has been mounted on the crane 9, the driving direction corresponds to a longitudinal axis 15 of the crane 9.

A guide rail 17 has been firmly arranged on the support 14, in this case attached to the support 14 by means of several braces 18. The guide rail 17 is also subdivided, here into two parts, in order to facilitate mounting and construction. In this drawing, the guide rail 17 is shaped as a circle and as a result of this, it is executed circumferentially around the entire support 14, extending here in a 90° angle to the longitudinal axis 15 of the support 14 or crane 9. However, deviating from the drawing shown here, it is also possible to arrange the guide rail 17 obliquely to the longitudinal axis 15 or the driving direction of the support 14. Here, two guiding sleds 19 are movably arranged on the guide rail 17 on which a guying device 16 has been fixed in each case. Although not described in detail here, the respective other end of the guying device 16 is connected to the component K of the wind turbine 1, not described in more detail here.

FIG. 3 shows an alternative execution of a device 2, in which the rail guide 17 has the shape of a circular segment. A rail guide 17 shaped like a circular segment can, in turn, be also arranged in its 90° angle and also with an inclination angle with regard to the longitudinal axis 15. Here, once again, two guiding sleds 19 are pivot mounted on the guide rail 17. The attachment to the components to be handled is not shown here, but can nonetheless take place by arranging the guying devices 16 directly on the component or by arranging the guying devices 16 above a seat 20 (see FIG. 6). This is also possible in the device 2 shown in FIG. 2.

As can additionally be seen in FIG. 3, a guide 21 is arranged on the crane tower 10 so the support 14 can be guided in a stable way. Using the device 2 shown in FIG. 3, it is possible to achieve a rotation of approximately 90° around the longitudinal axis 15, whereas in the drawing shown in FIG. 2 there is an advantageous free rotational capacity around the longitudinal axis 15.

FIG. 4 shows a detailed drawing of the support 14, which according to FIG. 4, is movable on the crane tower 10 by means of rollers 22. To achieve this, the support 14 has, for example, at least one roller block 23 in its corner area, in which a roller 22 is pivoted. In this case, it is advantageous if the rollers 22 are guided directly on the corner posts of the crane tower (as shown here) because then the device can be built simply and the device 2 would not need special guides 21 (cf. FIG. 3). So the support 14 can be guided directly on the corner posts 11 of the crane tower 10, it has on each one of its 4 corners at least two roller blocks 23 in perpendicular position to one another, each one with at least one roller 22. This attains stable guiding and prevents the support 14 from tilting on the crane 9.

Especially good guiding can be achieved if an obliquely arranged third roller 22 provides additional support and guiding, as shown in FIG. 5. According to this drawing, a set of rollers 22 is provided here both above and below the support 14 in each one of its corners, thereby achieving particularly good guiding.

A guide with rollers 22 can also be advantageous in the support 14 of FIG. 3, where the rollers 22 are arranged opposite one another, for example, and run on the guide 21.

According to the drawing of FIG. 4, two drives 24 arranged on two opposite sides of the support 14 and executed as cable winches are provided here to move the support 14. However, deviating from the drawing shown here, it is also possible to leave the support 14 without a drive and move it merely by hoisting the load downwards and upwards. Using an own drive 24, however, it is possible to have many controlled movements. Also advantageous here is that, depending on wishes and requirements, the carrier 14 can be moved synchronously both with the hoisting movement of component K and also independently of it.

FIG. 5 shows a detailed view of a support 14 mounted on a crane 9 (here a crane tower 10 of a rotating tower crane) with a section of a guide rail 17. A guiding sled 19 has been mounted on the guide rail 17, here provided with a winch 25, in order to adjust the tension and length of the guying device 16 exactly according to the requirements. The winches can be operated by remote radio control. Such guiding sleds 19 with a winch 25 can be advantageous, also with the devices 2 shown in FIGS. 2 and 3.

FIG. 6 shows an alternative execution of a device 2, in which an attachment 26 is pivot mounted on the guide rail 17 with four guiding sleds 19, as is the case here. In this case, the support 14 is essentially the one shown in FIG. 2, but it consists here of four support sections 14a, 14b. As can be seen in the drawing, at least one support section 14b has been executed so it can be dismantled in order to also facilitate mounting above the anchorage 32. Additionally recognizable are, in turn, the drives 24 to move the carrier 14 and the rollers 22, which are guided on corner posts 11.

Accordingly, the guide rail 17 consists of four parts of which each part, in turn, is connected to a support section 14a, 14b. The attachment 26 makes it possible to arrange the guying devices 16 in wide separation A from one another, thereby attaining significant stability when the component K is handled. To do this, the attachment 26 comprises two spacer struts 27 mounted in each case on the guide rail 17 by means of a guiding sled 19 and a connecting strut 28 for attachment. To connect with the guying devices 16, the attachment 26 has two winches 25 in this case, which are fixed here on the connecting strut 28. Naturally, other designs of such an attachment 26 are conceivable, in which several struts form a frame or also several connecting struts 28 can be provided. Likewise, even more spacer struts 27 can be provided. Finally, the winches 25 can be firmly attached to the spacer struts 27 as well instead of attaching them to the connecting struts 28. Furthermore, and deviating from the drawing shown here, winches 25 can also be arranged on a seat 20, so that in this case the guying devices 16 are firmly (i.e. non-adjustably) connected to the connecting strut 28.

As can also be seen in FIG. 6 and according to the present example, the device 2 includes furthermore a seat 20 for handling the component K, which can be a rotor blade 6. For example, it can be a stand surrounding the component K in which it can be safely accommodated. Here, the seat 20 furthermore includes a connecting arm 29 projecting towards both sides that likewise, in an especially advantageous way, makes it possible for the guying devices 16 to strike one another in a wide separation

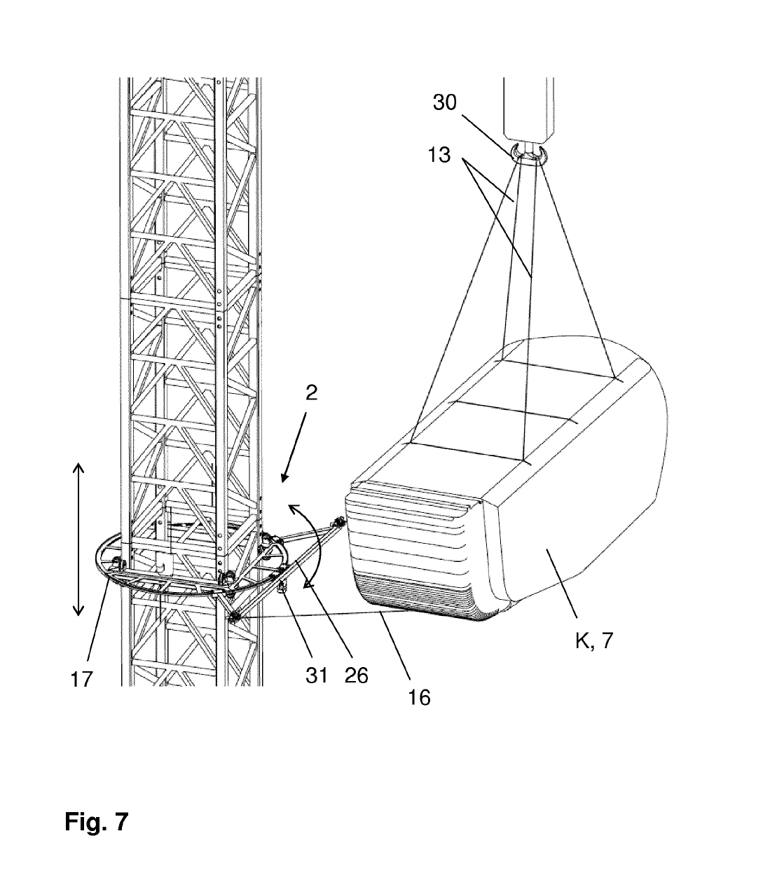

A′, thus contributing greatly to the stability of the handling process. Deviating from the drawing shown, it is naturally also possible to execute the connecting arm 29 so it merely projects on one side. By means of such a projecting connecting arm 29, long structural parts such as rotor blades 6, which tend to tilt around their center of gravity S, can be satisfactorily stabilized. Needless to say, depending on the component K to be picked up, the device 2 can also be executed without such seat 20, as shown in FIG. 7, for example.

FIG. 7 shows another execution of a device 2 or method for handling a component K, whereby once again an attachment 26 is provided so the component K, here the nacelle 7 of the wind turbine 1, is picked up but without a special seat 20. Apart from that, the structural design of the device 2 with the support 14, the guide rail 17, and the attachment 26 corresponds to the one shown in FIG. 6. What can still be seen in FIG. 7 is a travel drive 31 to move the attachment in controlled or controllable fashion on the guide rail 17. Preferably, the travel drive 31 can be remotely controlled by radio. The advantage of such a travel drive 31 is that it can serve simultaneously as a fixing device for the attachment 26 on the guide rail 17.

Such a travel drive 31 can also be used advantageously in the guiding sleds 19 shown in FIGS. 2, 3 and 5 or in the attachment 26 of FIG. 6 to move it on the circular path 17 in controlled fashion, thereby adjusting the position of the component K to be handled.

The invention is not restricted to the embodiments shown. Thus, even if merely rotor blades 6 or a nacelle 7 were shown, other structural parts of the wind turbine 1 such as, for example, annular or ring segment-shaped prefabricated parts of the tower 4 or steel sections of the tower 4 can be mounted in the same way by means of the device according to the invention. Furthermore, it is also possible to handle components K of the installation technology in this way. The crane 9 must not necessarily be executed as a rotating tower crane, and the device 2 according to the invention can also be used advantageously with other types of cranes 9. Additional combinations within the framework of the patent claims also fall under the invention.

### LIST OF REFERENCE CHARACTERS

1 Wind turbine

2 Device

3 Foundation

4 Tower

4a First section

4b Second section

5 Hub

6 Rotor blade

7 Nacelle

8 Intermediate piece

9 Crane

10 Crane tower

11 Corner posts

12 Boom

13 Load cable

14 Support

14a Support section

14b Support section

15 Longitudinal axis

16 Guying device

16a Guy cable

16b Bracing rod

17 Guide rail

18 Brace

19 Guiding sleds

20 Seat

21 Guide

22 Roller

23 Roller block

24 Drive

25 Winch

26 Attachment

27 Spacer strut

28 Connecting strut

29 Connecting arm

30 Hoist hook

31 Travel drive

32 Anchorage

A Separation at the attachment

A′ Separation at the seat

S Center of gravity

K Component

1. A device for handling components of a wind turbine with the aid of a crane, the device comprising:
a support movable in the direction of a longitudinal axis of the crane and attachable to the crane; and
at least one guying device having a first end is attached to the support and a second end attachable to the component of the wind turbine in order to stabilize the position of the component during handling, the guying device being rotatably attached to the support around a longitudinal axis of the crane.

2. A device according to claim 1, wherein a guide rail is arranged on the support, the guide rail extending at an angle to the longitudinal axis.

3. A device according to claim 2, wherein the guide rail is fixed to the support, and at least one guiding sled is pivotably mounted on the guide rail, and the at least one guying device is attached to the support via the guiding sled.

4. A device according to claim 2, wherein the guide rail fixed to the support, and an attachment having at least one guiding sled is pivotably mounted on the guide rail, and the at least one guying device is attached to the support via the attachment.

5. A device according to claim 4, wherein at least one of the attachment and the at least one guiding sled can be locked in place on the guide rail.

6. A device according to claim 1, further including a seat for the component of the wind turbine, the at least one guying device being attachable to the component of the wind turbine via the seat.

7. A device according to claim 1, wherein the at least one guying device is a guy cable, and at least one winch is arranged on one of at least one guiding sled, an attachment, and a seat via which the length of the guy cable can be changed.

8. A device according to claim 7, wherein the attachment has at least two of the guiding sleds and at least of the two winches.

9. A device according to claim 4, wherein the at least one guiding sled has a travel drive to turn at least one of the at least one guying device and the attachment.

10. A device according to claim 1, wherein the support has rollers that can be guided on corner posts of a crane tower of the crane.

11. A device according to claim 1, wherein the support fully surrounds the crane.

12. A device according to claim 1, wherein the support has at least one drive.

13. A method to handle components of a wind turbine (1) with the aid of a crane comprising the steps of:
stabilizing the position of the components using at least one guying device;
vertically hoisting the components towards a longitudinal axis of the crane; and
moving the at least one guying device around the longitudinal axis at least one of before, during and after the vertical hoisting step.

14. A method according to claim 13, wherein the at least one guying device is guided on a circular path around the longitudinal axis.

15. A method according to claim 14, wherein the at least one guying device is guided on the circular path in a controlled movement.

16. A method according to claim 13, wherein the component is hoisted via a seat, the at least one guying device (16) being fixed in place on the seat.

17. A method according to claim 13, wherein a support is led substantially synchronously with the hoisting movement of the component.
